(19) United States
(12) Patent Application Publication
(10) Pub. No.: US 2025/0003669 A1
(43) Pub. Date: Jan. 2, 2025

(54) EXHAUST CONDENSATION RECOVERY DEVICE

(71) Applicant: WE SOLUTIONS TECHNOLOGY CO., LTD, Taoyuan City (TW)

(72) Inventors: CHUNG-PENG HUANG, Taoyuan City (TW); FANG-YI LIN, Taoyuan City (TW); KUAN-LIN CHEN, Taoyuan City (TW); CHUN-CHING KUO, Taoyuan City (TW)

(21) Appl. No.: 18/429,444

(22) Filed: Feb. 1, 2024

Related U.S. Application Data
(60) Provisional application No. 63/511,185, filed on Jun. 30, 2023.

(51) Int. Cl. F25D 21/14; F25B 21/02

(52) U.S. Cl. CPC F25D 21/14; F25B 21/02

(57) ABSTRACT

An exhaust condensation recovery device for solving an issue of difficulties in removing a gaseous working fluid diffused in an outer hood. An exhaust condensation recovery device includes a housing, including a gas inflow portion, a liquid inflow portion and a gas outflow portion, the housing including therein an accommodating chamber, wherein a liquid collection zone is formed below accommodating chamber, and the liquid outflow portion is in communication with the liquid collection zone; and a cooling module, forming a condensation channel in the accommodating chamber, wherein the condensation channel is located above the liquid collection zone, and two ends of the condensation channel are respectively in communication with the gas inflow portion and the gas outflow portion.

### CROSS-REFERENCE TO RELATED APPLICATION

This non-provisional application claims priority under 35 U.S.C. § 119(e) on U.S. provisional Patent Application No(s). 63/511,185 filed on Jun. 30, 2023, the entire contents of which are hereby incorporated by reference.

### BACKGROUND OF THE INVENTION

### 1. Field of the Invention

The resent disclosure relates to a gas processing device, and in particular to an exhaust condensation recovery device for condensing and collecting a gaseous working fluid.

### 2. Description of the Related Art

In industrial processes or high-performance computing devices, gases with environmental pollution or health hazards frequently need to be used. To prevent related gas leakage or waste, it is necessary for cabinets of related apparatuses or devices be designed with good airtightness.

For example, accompanied with rapid increases in powers and heat flux densities of heating components of electronic elements related to computing in computers, immersion cooling is one of the most effective techniques to quickly reduce the amount of heat generated by electronic computing elements. In two-phase immersion cooling, phase change heat transfer is performed in an enclosed space of a cabinet, and a coolant (such as perfluoro-ketone approaching a boiling point of 50° C.) boils and becomes a gaseous coolant. The gaseous coolant is condensed through a condenser tube above, transforms back into a liquid and returns to a lower part. Thus, without needing to provide additional resources or pump power for heat dissipation, an effect of coolant circulation is achieved.

### BRIEF SUMMARY OF THE INVENTION

However, during maintenance and repair or component replacement of a two-phase immersion cooling device, an upper lid of the cooling device needs to be first opened. In order to prevent a gaseous cooling from diffusing to plant areas and machine rooms or even further into the atmosphere, an outer hood is in general commonly used for isolation. However, after component replacement is complete and the upper lid of the cooling device is closed, part of the gaseous coolant may remain in the outer hood. If the gaseous coolant is not completely eliminated before the outer hood is removed, in addition to causing environmental safety problems, an enhanced recovery rate of the costly coolant can be made challenging such that operation costs cannot be effectively reduced.

In view of the above, the present disclosure provides an exhaust condensation recovery device, which is capable of condensing and collecting a gaseous working fluid remaining in an outer hood and significantly reducing an amount of the remaining gaseous working fluid in the outer hood, so that the outer hood can be removed safety. Moreover, the working liquid condensed back into a liquid state can be recycled to reduce operation costs.

The directional or similar terms used throughout the literature of the present disclosure, for example, “front”, “back/rear”, “left”, “right”, “up/upper/top”, “down/lower/bottom”, “in/inner”, “out/outer” and “side surface”, are primarily given with reference to the directions of the drawings. These directional or similar terms are intended to assist in describing and better understanding various embodiments of the present disclosure and are not to be construed as limitations to the present disclosure. Regarding the description related to water or a liquid, one through which a waterflow passes first is referred to as “front”, and one through which a waterflow passes later is referred to as “back”.

The articles “a/an” and “one” used for the elements and components described throughout the literature of the present disclosure are merely for the ease of use and to provide common meaning of the scope of the present disclosure, and should be interpret as “one” or “at least one” in the present disclosure. Moreover, the concept of a singular form also includes cases of plural forms, unless otherwise specified.

Similar terms including “join”, “combine”, “couple” or “assemble” used throughout the literature of the present disclosure primarily include forms which can be separated without sabotaging the components or contain inseparable components once connected, and can be selected by a person skilled in the art according to materials or assembly requirements of the components to be connected.

To achieve the above and other objects, an exhaust condensation recovery device provided by the present disclosure includes: a housing, including a gas inflow portion, a liquid inflow portion and a gas outflow portion, the housing including therein an accommodating chamber, wherein a liquid collection zone is formed below accommodating chamber, and the liquid outflow portion is in communication with the liquid collection zone; and a cooling module, forming a condensation channel in the accommodating chamber, wherein the condensation channel is located above the liquid collection zone, and two ends of the condensation channel are respectively in communication with the gas inflow portion and the gas outflow portion.

In the exhaust condensation recovery device above, the cooling module can include a thermoelectric cooling module, a first fin group and a second fin group. The first fin group can be thermally connected to a cold end of the thermoelectric cooling module and can extend into the accommodating chamber. The second fin group can be located in the accommodating chamber, and the second fin group and the first fin group can together form the condensation channel.

In the exhaust condensation recovery device above, each of the first fin group and the second fin group can include a plurality of fins disposed on a substrate, and a plurality of fins of the first fin group can be alternately arranged with a plurality of fins of the second fin group so as to together form the condensation channel having a serpentine shape.

The exhaust condensation recovery device above can further include a heat dissipation module. The heat dissipation module can include a third fin group located outside the housing, and the third fin group can be thermally connected to a hot end of the thermoelectric cooling module.

In the exhaust condensation recovery device above, the housing can include a bottom plate and a surrounding wall. The surrounding wall is connected to the bottom plate to together form the accommodating chamber. The liquid collection zone can be adjacent to the bottom plate. The surrounding wall can form an opening, a substrate of the first fin group can seal the opening, and a substrate of the third fin group can be fixedly connected to the surrounding wall and sandwich the thermoelectric cooling module between the third fin group and the first fin group.

In the exhaust condensation recovery device above, the third fin group can include a plurality of fins disposed on a substrate, and the substrate of the third fin group can be thermally connected to the hot end of the thermoelectric cooling module. The heat dissipation module can include a cooling fan group, which can be used to drive air amidst the plurality of fins of the third fin group to flow.

In the exhaust condensation recovery device above, the cooling fan group can include a support frame and a plurality of cooling fans. The support frame can include a plurality of through holes, and the plurality of cooling fans can be respectively coupled at the support frame and are aligned with the corresponding through holes. An airway is formed between any two adjacent fins of the third fin group, and the support frame can be in an open form on both ends of the airway.

In the exhaust condensation recovery device above, the housing can include therein at least one confluence sloped surface located in the liquid collection zone, and the liquid outflow portion can be located at a low position of the confluence sloped surface

In the exhaust condensation recovery device above, the housing can include a surrounding wall connected to a bottom plate to together form the accommodating chamber, the second fin group can include a plurality of fins disposed on a substrate, the substrate of the second fin group can be disposed obliquely in the accommodating chamber, both ends of each fin of the second fin group can be individually connected to the surrounding wall, a lower edge of the substrate can be not connected to the surrounding wall, and a liquid communicating hole can be formed between any two adjacent fins between the lower edge of the substrate and the surrounding wall.

The exhaust condensation recovery device above can further include a filter module, which can be in communication with the gas outflow portion.

Accordingly, the exhaust condensation recovery device above of the present disclosure is capable of guiding a gaseous working liquid to pass through the condensation channel of the cooling module, so as to condense the gaseous working liquid into a liquid to be readily collected. Thus, the amount of the gaseous working liquid remaining in an outer hood assembled at a cabinet can be significantly reduced, so as to safely remove the outer hood and restore normal operations of the cabinet and ensure operation environment safety for staff. Moreover, the working liquid condensed back into a liquid state can be recycled to achieve an effect of reduced operation costs.

### BRIEF DESCRIPTION OF THE DRAWINGS

FIG. 1 is an exploded perspective schematic diagram according to an embodiment of the disclosure.

FIG. 2 is a perspective schematic diagram according to an embodiment of the present disclosure, with a part of a surrounding wall omitted therefrom.

FIG. 3 is a bottom schematic diagram according to an embodiment of the disclosure.

FIG. 4 is a section schematic diagram along the section line A-A in FIG. 3.

FIG. 5 is a schematic diagram of a flow direction of a working liquid according to an embodiment of the disclosure.

FIG. 6 is a section schematic diagram along the section line B-B in FIG. 3.

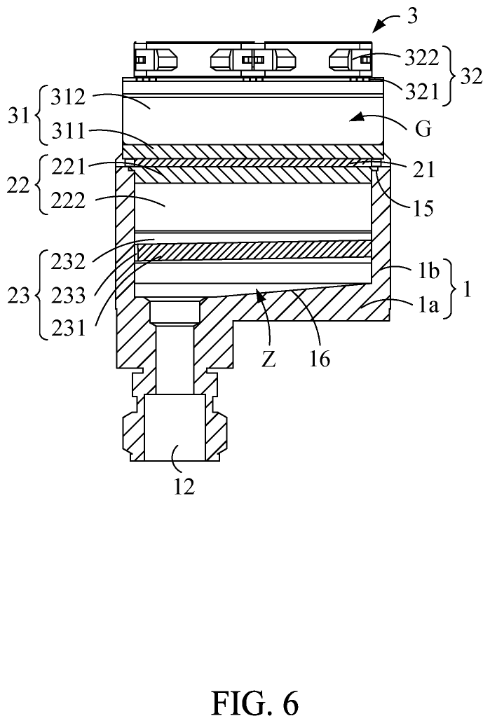

FIG. 7 is an exploded perspective schematic diagram of a heat dissipation module according to an embodiment of the disclosure.

FIG. 8 is a partial perspective schematic diagram according to an embodiment of the present disclosure, with a part of a surrounding wall omitted therefrom.

### DETAILED DESCRIPTION OF THE INVENTION

To facilitate understanding of the object, characteristics and effects of this present disclosure, embodiments together with the attached drawings for the detailed description of the present disclosure are provided.

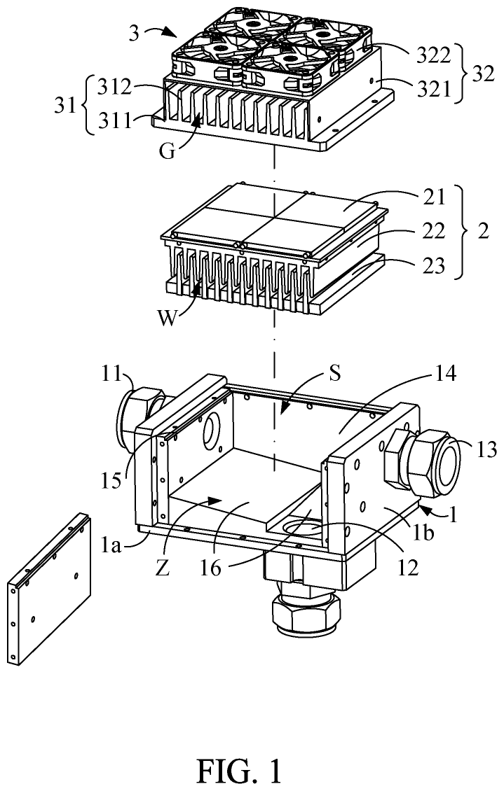

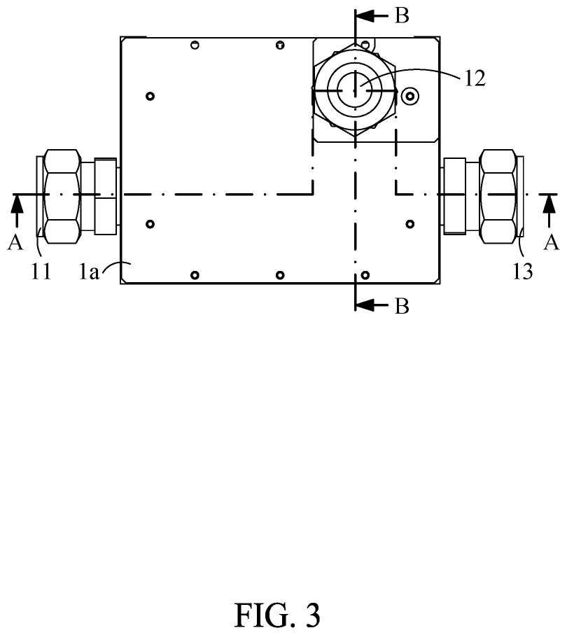

Referring to FIG. 1 to FIG. 4 showing an exhaust condensation recovery device according to a preferred embodiment of the present disclosure. The exhaust condensation recovery device includes a housing 1 and a cooling module 2, wherein the cooling module 2 is disposed at the housing 1.

More specifically, the housing 1 includes a gas inflow portion 11, a liquid outflow portion 12 and a gas outflow portion 13. The housing 1 has an accommodating chamber S therein, and a liquid collection zone Z is formed below the accommodating chamber S. The present disclosure does not specifically define the form of the housing 1. The form of the housing 1 can be modified to match a cabinet to be assembled to, and is in principle designed to be able to securely setting up the components such as the cooling module 2. In one embodiment of the present disclosure, the housing 1 can include a bottom plate 1a and a surrounding wall 1b, the surrounding wall 1b is connected to the bottom wall 1a so as to together form the accommodating chamber S, and the liquid collection zone Z is adjacent to the bottom plate 1a. A peripheral edge of the surrounding wall 1b not connected to the bottom plate 1a can encircle to form an opening 14. The opening 14 can be opposite to the bottom plate 1a, so as to readily assemble the cooling module 2 via the opening 14. The cooling module 2 forms a condensation channel W in the accommodating chamber S. The condensation channel W is located above the liquid collection zone Z, and two ends of the condensation channel W are respectively in communication with the gas inflow portion 11 and the gas outflow portion 13. The gas outflow portion 12 is in communication with the liquid collection zone Z.

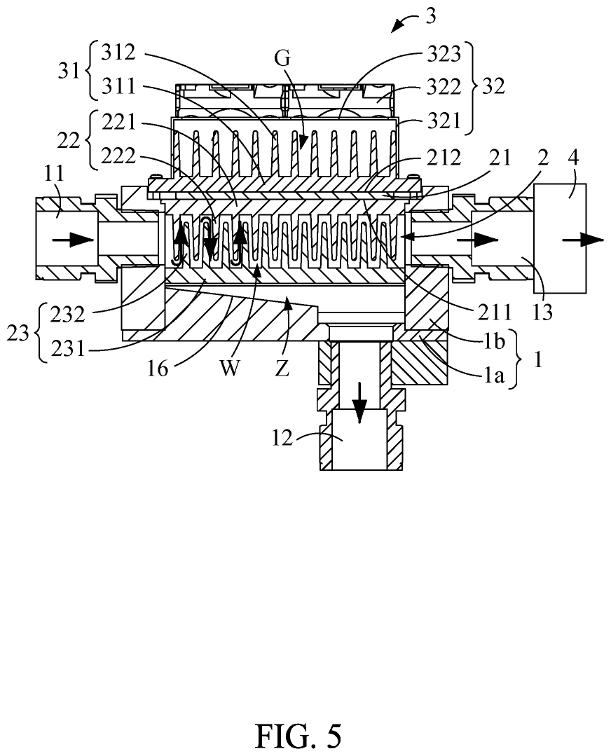

Accordingly, referring to FIG. 5, a gaseous working fluid remaining in an outer hood assembled to the cabinet can flow through the gas inflow portion 11 and into the condensation channel W, and is cooled down and condensed back to a liquid state in the condensation channel W while flowing toward the gas outflow portion 13. Thus, the liquid working fluid can drip and flow into the liquid collection zone Z below the condensation channel W, and be discharged via the liquid outflow portion 12, for example, guided back to a cavity accommodating a liquid working fluid in the cabinet, so as to recycle of the working liquid for further use.

Thus, the exhaust condensation recovery device of the present disclosure is capable of guiding a gaseous working liquid to pass through the condensation channel W of the cooling module 2, so as to condense the gaseous working liquid into a liquid to be readily collected. Thus, the amount of the gaseous working liquid remaining in an outer hood assembled at a cabinet can be significantly reduced, so as to safely remove the outer hood and restore normal operations of the cabinet and ensure operation environment safety for staff. Moreover, the working liquid condensed back into a liquid state can be recycled to achieve an effect of reduced operation costs.

Referring to FIG. 1, in one embodiment of the present disclosure, the surrounding wall 1b of the housing 1 can be formed together by a plurality of plates in an encircling manner, and the gas inflow portion 11 and the gas outflow portion 13 can be disposed at the surrounding wall 1b and can be selectively disposed on different sides or the same side of the surrounding wall 1b according to pipeline configuration requirements. Moreover, each of the gas inflow portion 11, the liquid outflow portion 12 and the gas outflow portion 13 can display, for example but not limited to, a form of a connector so as to be readily connected to a pipeline. In addition, the surrounding wall 1b can have at least one shoulder 15 formed thereon for assembling and positioning the cooling module 2.

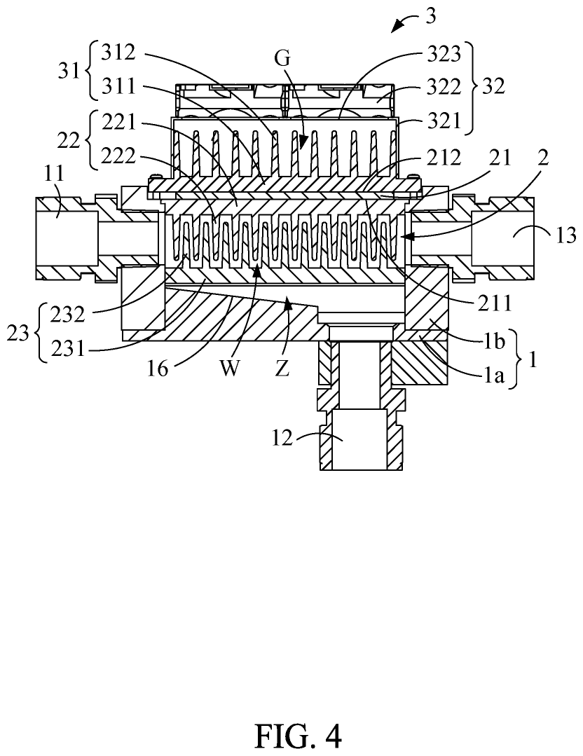

Referring to FIG. 1 and FIG. 4, in addition to the embodiments above, in one embodiment of the present disclosure, the cooling module 2 can include a thermoelectric cooling module 21, a first fin group 22 and a second fin group 23. The first fin group 22 can be thermally connected to a cold end 211 of the thermoelectric cooling module 21 and extend into the accommodating chamber S. The second fin group 23 can be located in the accommodating chamber S, and the second fin group 23 and the first fin group 22 can together form the condensation channel W. For example, the first fin group 22 and the second fin group 23 can respectively include substrates 221 and 231 and a plurality of fins 222 and 232, wherein the plurality of fins 222 and 232 can be located on one of the surfaces of the substrates 221 and 231. In this embodiment, the first fin group 23 can be disposed opposite to the first fin group 22, such that the plurality of fins 222 of the first fin group 22 can be alternately arranged with the plurality of fins 232 of the second fin group 23 to form the condensation channel W having a serpentine shape between the second fin group 23 and the first fin group 22. Thus, the cold end 211 of the thermoelectric cooling module 21 can keep the first fin group 22 in a low temperature state, so that the gaseous working liquid can come into contact with the plurality of fins 222 in a low temperature and be condensed into liquid while flowing through the condensation channel W, and the serpentine condensation channel W is capable of elongating a condensation path for the gaseous working liquid to allow the gaseous working liquid to fully condensate into a liquid state in the condensation channel W.

In addition to the embodiments above, in one embodiment of the present disclosure, the exhaust condensation recovery device can further include a heat dissipation module 3. The heat dissipation module 3 can include a third fin group 31 located outside the housing 1, and the third fin group 31 can be thermally connected to a hot end 212 of the thermoelectric cooling module 21. The third fin group 31 can include a substrate 311, and the plurality of fins 312 which can be located on a surface of the substrate 311. The third fin group 31 can be thermally connected to the hot end 212 of the thermoelectric cooling module 21 via the substrate 311, so as to absorb heat energy that the thermoelectric cooling module 21 produces for maintaining the low temperature of the first fin group 22, hence performing heat exchange with an environment outside the housing 1 by the plurality of fins 312 and achieving a heat dissipation effect.

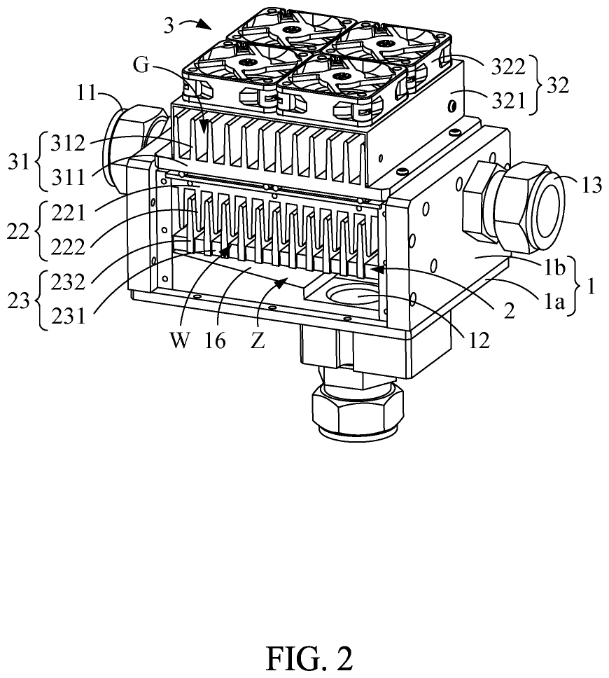

Referring to FIG. 2 and FIG. 4, in one embodiment of the present disclosure, the substrate 221 of the first fin group 22 can be abutted against the shoulder 15 of the surrounding wall 1a so as to seal the opening 14 of the housing 1. The substrate 311 of the third fin group 31 can, for example, be fixedly connected to the surrounding wall 1b by a plurality of lock members, and securely sandwich the thermoelectric cooling module 21 between the third fin group 31 and the first fin group 22. Thus, the cooling module 2 and the heat dissipation module 3 can be assembled to the housing 1. Moreover, once the cooling module 2 is assembled, the opening 14 of the housing 1 is also sealed to allow the accommodating chamber S to form a sealed cavity, hence preventing the gaseous working liquid from seeping out via the opening 14 of the housing 1.

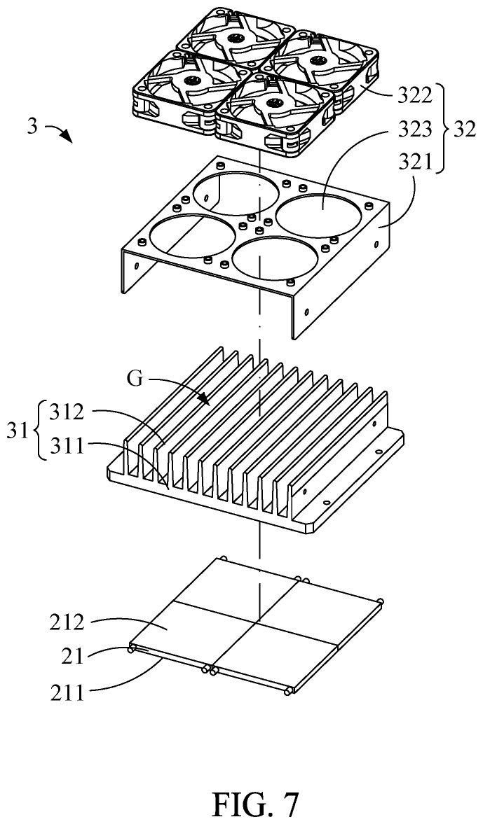

Referring to FIG. 1 and FIG. 7, in one embodiment of the present disclosure, the heat dissipation module 3 can further include a cooling fan group 32 which can assist in heat dissipation of the third fin group 21. That is, the cooling fan group 32 can drive air amidst the plurality of fins 312 of the third fin group 33 to flow. Thus, whether the cooling fan group 32 blows or withdraws air relative to the third fin group 31, air with increased temperature can be prevented from residing amidst the plurality of fins 312 and thus from degrading the heat dissipation efficiency of the third fin group 31 for the thermoelectric cooling module 21.

In one embodiment of the present disclosure, the cooling fan group 32 can include a support frame 321 and a plurality of cooling fans 322. The support frame 321 can include a plurality of through holes 323, and the plurality of cooling fans 322 can be respectively combined at the support frame 321 and be aligned with the corresponding through holes 323, so as to blow or withdraw an airflow toward or from amidst the plurality of fins 312 via the corresponding through holes 323. An airway G can be formed between any two adjacent fins 312 of the third fin group 31, and the support frame 321 displays an open form on both ends of the airway G so as to maintain smooth air circulation of each airway G. For example, the support frame 321 can have a substantially U shape, cross the plurality of fins 312, and be combined with two outermost fins 312.

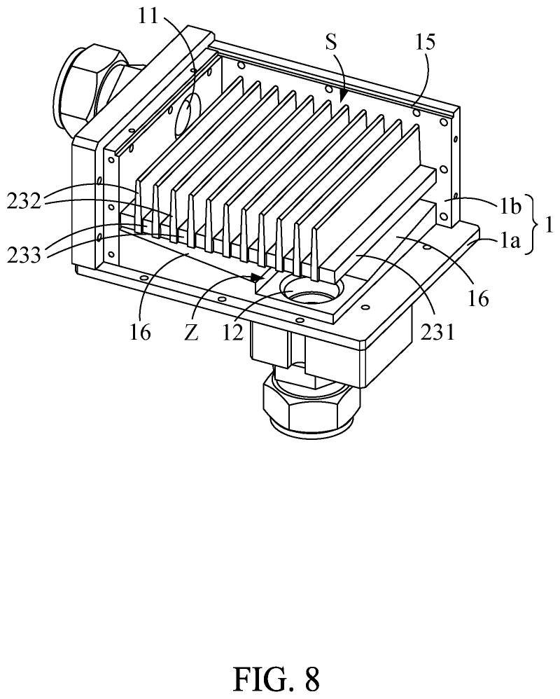

Referring to FIG. 4 and FIG. 8, in addition to the embodiments above, in one embodiment of the present disclosure, the housing 1 can include therein at least one confluence sloped surface 16 located in the liquid collection zone Z, and the liquid outflow portion 12 is preferably located at a low position of the confluence sloped surface 16. For example, the confluence sloped surface 16 can be formed by an inner surface of the housing 1, or as shown in the drawings, at least one wedge block is formed on the bottom plate 1a so as to form the confluence sloped surface 16. Thus, with a simple structure of this embodiment, the liquid working fluid dripped in the liquid collection zone Z can be more smoothly discharged through the liquid outflow portion 12, hence reducing the amount of liquid remaining in the housing 1.

Referring to FIG. 4 and FIG. 8, in addition to the embodiments above, in one embodiment of the present disclosure, the substrate 231 of the second fin group 23 can be disposed as being slightly oblique in the accommodating chamber S, both ends of each fin 232 of the second fin group 23 can be individually connected to an inner wall surface of the surrounding wall 1b, and a lower edge of the substrate 231 of the second fin group 23 can be not connected to the inner wall surface of the surrounding wall 1b, so that a liquid communicating hole 233 can be formed between any two adjacent fins 23 between the lower edge of the substrate 231 of the second fin group 23 and the surrounding wall 1b. Thus, drops of the working liquid condensed in the condensation channel W can flow along the oblique substrate 232 toward a lower position, and flow into the liquid collection zone Z through the corresponding liquid communicating hole 233. Thus, with a simple structure of this embodiment, the liquid working fluid is enabled to smoothly flow into the liquid collection zone Z, and the amount of liquid remaining between any two adjacent fins 232 can be reduced. In other embodiments, the substrate 231 of the second fin group 23 can also disposed in a manner other than being oblique, and a plurality of holes can be directly provided on the substrate 231 so as to allow the liquid working fluid to pass through the plurality of holes and flow downward into the liquid collection zone Z.

Referring to FIG. 5, in addition to the embodiments above, in one embodiment of the present disclosure, the exhaust condensation recovery device can further include a filter module 4, which can be in communication with the gas outflow portion 13; for example, the filter module 4 can include an active carbon filter layer. Thus, even if a gas flowing out from the condensation channel W via the gas outflow portion 13 contains a small amount of working fluid, the working fluid can be filtered out by the filter module 4, hence ensuring that a gas discharged into a working environment does not contain any gas hazardous to the human health

The present invention is described by way of the preferred embodiments above. A person skilled in the art should understand that, these embodiments are merely for describing the present invention are not to be construed as limitations to the scope of the present invention. It should be noted that all equivalent changes, replacements and substitutions made to the embodiments are to be encompassed within the scope of the present invention. Therefore, the scope of protection of the present invention should be accorded with the broadest interpretation of the appended claims.

What is claimed is:

1. An exhaust condensation recovery device, comprising:
a housing, comprising a gas inflow portion, a liquid outflow portion and a gas outflow portion, the housing having an accommodating chamber, wherein a liquid collection zone is formed below the accommodating chamber, the liquid outflow portion is in communication with the liquid collection zone; and
a cooling module, forming a condensation channel in the accommodating chamber, the condensation channel located above the liquid collection zone, and two ends of the condensation channel respectively being in communication with the gas inflow portion and the gas outflow portion.

2. The exhaust condensation recovery device according to claim 1, wherein the cooling module comprises a thermoelectric cooling module, a first fin group and a second fin group, the first fin group is thermally connected to a cold end of the thermoelectric cooling module and extends into the accommodating chamber, the second fin group is located in the accommodating chamber, and the second fin group and the first fin group together form the condensation channel.

3. The exhaust condensation recovery device according to claim 2, wherein each of the first fin group and the second fin group comprises a plurality of fins disposed on a substrate, and the plurality of fins of the first fin group are alternately arranged with the plurality of fins of the second fin group so as to together form the condensation channel having a serpentine shape.

4. The exhaust condensation recovery device according to claim 2, further comprising a heat dissipation module which comprises a third fin group located outside the housing, wherein the third fin group is thermally connected to a hot end of the thermoelectric cooling module.

5. The exhaust condensation recovery device according to claim 4, wherein the housing comprises a bottom plate and a surrounding wall, the surrounding wall is connected to the bottom plate to together form the accommodating chamber, the liquid collection zone is adjacent to the bottom plate, the surrounding wall has an opening formed thereon, a substrate of the first fin group seals the opening, and a substrate of the third fin group is fixedly connected to the surrounding wall and sandwiches the thermoelectric cooling module between the third fin group and the first fin group.

6. The exhaust condensation recovery device according to claim 4, wherein the third fin group comprises a plurality of fins disposed on a substrate thereof, the substrate of the third fin group is thermally connected to the hot end of the thermoelectric cooling module, and the heat dissipation module comprises a cooling fan group which drives air amidst the plurality of fins of the third fin group to flow.

7. The exhaust condensation recovery device according to claim 6, wherein the cooling fan group comprises a support frame and a plurality of cooling fans, the support frame comprises a plurality of through holes, the plurality of cooling fans are respectively coupled at the support frame and are aligned with the corresponding through holes, an airway is formed between any two adjacent fins of the third fin group, and the support frame is in an open form on both ends of the airway.

8. The exhaust condensation recovery device according to claim 1, wherein the housing comprises therein at least one confluence sloped surface located in the liquid collection zone, and the liquid outflow portion is located at a low position of the confluence sloped surface.

9. The exhaust condensation recovery device according to claim 1, wherein the housing comprises a surrounding wall connected to a bottom plate to together form the accommodating chamber, the second fin group comprises a plurality of fins disposed on a substrate thereof, the substrate of the second fin group is disposed obliquely in the accommodating chamber, both ends of each fin of the second fin group are individually connected to the surrounding wall, a lower edge of the substrate is not connected to the surrounding wall, and a liquid communicating hole is formed between any two adjacent fins between the lower edge of the substrate and the surrounding wall.

10. The exhaust condensation recovery device according to claim 1, further comprising a filter module which is in communication with the gas outflow portion.

11. The exhaust condensation recovery device according to claim 2, further comprising a filter module which is in communication with the gas outflow portion.

12. The exhaust condensation recovery device according to claim 3, further comprising a filter module which is in communication with the gas outflow portion.

13. The exhaust condensation recovery device according to claim 4, further comprising a filter module which is in communication with the gas outflow portion.

14. The exhaust condensation recovery device according to claim 5, further comprising a filter module which is in communication with the gas outflow portion.

15. The exhaust condensation recovery device according to claim 6, further comprising a filter module which is in communication with the gas outflow portion.

16. The exhaust condensation recovery device according to claim 7, further comprising a filter module which is in communication with the gas outflow portion.

17. The exhaust condensation recovery device according to claim 8, further comprising a filter module which is in communication with the gas outflow portion.

18. The exhaust condensation recovery device according to claim 9, further comprising a filter module which is in communication with the gas outflow portion.
